(19) United States
(12) Patent Application Publication
(10) Pub. No.: US 2008/0266447 A1
(43) Pub. Date: Oct. 30, 2008

(54) Camera module and electronic device including same

(75) Inventors: Yoshikazu Ohara, Fukuyama-shi (JP); Kazuo Kinoshita, Fukuyama-shi (JP)

Correspondence Address: Edwards Angell Palmer & Dodge LLP, P.O. Box 55874, Boston, MA, 02205, US

(73) Assignee: Sharp Kabushiki Kaisha, Osaka (JP)

(21) Appl. No.: 12/080,349

(22) Filed: Apr. 2, 2008

(30) Foreign Application Priority Data
Apr. 4, 2007 (JP) 2007-098802

(51) Int. Cl. H04N 5/225

(52) U.S. Cl. 348/374; 348/E05.024

(57) ABSTRACT

A camera module 100 according to the present invention includes a lens unit 1 including a lens 11, and an imaging unit 2 where a solid-state imaging element is mounted on a wiring board 21, the lens unit 1 and the imaging unit 2 being engaged with each other by inserting a projection 23 into a cutout part 13, the projection 23 being provided on the imaging unit 2, and the cutout part 13 being provided on the lens unit 1. The cutout part 13 has a cross-sectional shape that is in parallel with an opening surface 13a and that becomes smaller inwardly of the lens unit 1. Thus, when detaching each unit, breaking of the projection can be prevented and each unit can be easily detached. With this arrangement it is possible to realize a camera module in which a disengagement of an optical unit and an imaging unit can be performed easily, while effectively preventing the breaking of the projection when detaching the optical unit and the imaging unit.

This Nonprovisional application claims priority under 35U.S.C. § 119(a) on Patent Application No. 098802/2007 filed in Japan on Apr. 4, 2007, the entire contents of which are hereby incorporated by reference.

### FIELD OF THE INVENTION

The present invention relates to an optical unit which can change, by electromagnetic force, a position of a lens supported by a lens holder, a solid-state imaging device and an electronic device, which include the optical unit.

### BACKGROUND OF THE INVENTION

In the conventional camera module, an optical structure (housing) including optical parts such as a lens and an IR filter is fixed with an adhesive on an element substrate on which a terminal is formed. According to this arrangement, however, the optical structure can not be detached from the element substrate. Therefore in the final test of manufacturing process of a camera module, even a faultless element substrate must be scrapped for example, in the case where a defect is found only in an optical structure.

A camera module which can separate an optical structure from an element substrate is disclosed in Patent document 1. FIG. 5 is an exploded cross-sectional view of a camera module 200 described in Patent document 1.

The camera module 200 includes an optical structure 201 including a lens, an element substrate 202 on which a solid-state imaging element is mounted, and a intermediate structure 203 arranged between the optical structure 201 and the element substrate 202. The camera module 200 is arranged such that the optical structure 201 and the element substrate 202 are engaged with each other with the intermediate structure 203 interposed therebetween.

Specifically, as shown in FIG. 5, the camera module 200 includes a projection 219, a cutout part 220, a pinching projection 224 and a cutout part 225 in order to make the optical structure 201 detachable from the element substrate 202. The projection 219 is configured to fit in the cutout part 220, and the pinching projection 224 is configured to fit in the cutout part 225. This enables the optical structure 201 and the element substrate 202 (intermediate structure 203) to be engaged surely. In other words, an adhesive is not needed when fixing the optical structure 201 with the element substrate 202.

Therefore, if a defect is found in the optical structure 201 or the element substrate 202 after fitting the optical structure 201 with the element substrate 202, it is possible to exchange only defective parts.

Patent Document 1

Japanese Unexamined Patent Application Publication No. 2005-175971 (disclosed on Jun. 30, 2005)

However, in the camera module 200 disclosed in Patent document 1, when detaching the optical structure 201 from the element substrate 202 (intermediate structure 203), there is risk of breaking the projection 219 and the pinching projection 224.

This will be explained more specifically below. Assume that a defect is found in the optical structure 201 or the element substrate 202 after fitting the projection 219 with the cutout part 220 and fitting the pinching projection 224 with the cutout part 225 respectively. In this case, the defective part must be replaced by detaching the optical structure 201 and the element substrate 202 from each other. In this fitting state, however, the projection 219 is in close contact with the cutout part 220 and the pinching projection 224 is in close contact with the cutout part 225. Thus, it is not easy to detach the optical structure 201 from the element substrate 202.

Furthermore, FIG. 6 is a cross-sectional view of the camera module 200 showing the optical structure 201 that is being detached from the element substrate 202. As FIG. 6 shows, in the camera module 200, the optical structure 201 is rotated about the projection 219 and the cutout part 220, in order to detach the optical structure 201 from the element substrate 202. However, in the state where the pinching projection 224 fits in the cutout part 225, a movement of the pinching projection 224 is restricted by the cutout part 225 until the pinching projection 224 comes out from the cutout part 225 completely. Thus, a great amount of force is applied to the pinching projection 224 in the direction to which the cutout part 225 moves. In other words, an excessive force is applied to the pinching projection 224 continuously until the optical structure 201 comes out of the element substrate 202. Consequently, the pinching projection 224 will be broken by the force. And even parts which do not require replacement (optical structure 201 or the element substrate 202) will be broken.

### SUMMARY OF THE INVENTION

The present invention was accomplished in view of the conventional problems, and an object of the present invention is to offer a camera module in which an optical unit and an image unit engaged with each other by a projection and a cutout part can be detached from each other easily without breaking the projection.

In order to attain the object, a camera module according to the present invention is a camera module including an optical unit including a lens for leading external light to a solid-state imaging element; and an imaging unit where the solid-state imaging element is mounted on a substrate, the camera module comprising: at least one pair of a projection and a cutout part corresponding to the projection, the projection being provided on at least one of the optical unit and the imaging unit, and the cutout part being provided on that one of the optical unit and the imaging unit on which the projection to which the cutout part corresponds is not provided, the optical unit and the imaging unit being engaged with each other by inserting the projection into the cutout part, and the cutout part being having a cross-sectional shape that is in parallel with an opening thereof and that becomes smaller inwardly of that one of the optical unit and the imaging unit in which the cutout part is provided.

A camera module according to the present invention is arranged such that the optical unit including the lens and the imaging unit including the solid-state imaging element are engaged with each other detachably. The engagement is performed by inserting the projection of one unit into the cutout part of the other unit.

According to the above arrangement, the cutout part being having a cross-sectional shape that is in parallel with an opening thereof and that becomes smaller inwardly of that one of the optical unit and the imaging unit in which the cutout part is provided. In other words, the cutout part becomes thinner (narrower) inwardly of the unit. Thus, the engagement can be easily released by moving the optical unit relatively to an imaging unit. Therefore each unit can be easily detached from each other.

Further, the cutout part becomes thicker in the direction in which each unit is detached (in the direction in which an engagement between each unit is released). Thus, even before the projection is removed from the cutout part (even in the middle of detaching each unit), there is some space where the projection can move in the cutout part. Thus, as long as the engagement is released, an excessive amount of force will not be applied to the projection even in the middle of detaching each unit. Therefore the breaking of the projection can be prevented when each unit is detached from each other.

In order to attain the object, an electronic device according to the present invention includes the camera module. This makes it possible to realize an electronic device in which the breaking of the projection can be prevented and each unit can be easily detached from each other.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1(a) is a cross-sectional view showing a camera module according to an embodiment of the present invention while detaching a lens unit from an imaging unit.

FIG. 1(b) is a top perspective view of the camera module shown in FIG. 1(a).

FIG. 2(a) is a cross-sectional view of a camera module according to an embodiment of the present invention.

FIG. 2(b) is a top perspective view of the camera module shown in FIG. 2(a).

FIG. 3(a) is a plan view of a camera module according to an embodiment of the present invention.

FIG. 3(b) is a cross-sectional view taken along B-B line of the camera module shown in FIG. 3(a).

FIG. 3(c) is a side view of a camera module 100 viewed in the X direction.

FIG. 4 is a exploded view of the camera module shown in FIG. 3(a) to FIG. 3(c).

FIG. 5 is a cross-sectional view of a camera module described in Patent document 1.

FIG. 6 is a cross-sectional view showing the camera module shown in FIG. 5 while detaching an optical structure from an element substrate.

### DESCRIPTION OF THE EMBODIMENT

The following explains an embodiment of the present invention with reference to the drawings.

A camera module (solid-state imaging device) according to the present invention can be applied suitably to electronic devices capable of capturing an image, such as camera-equipped mobile phones, digital still cameras and security cameras. In the present embodiment, a camera module used in camera-equipped mobile phones is explained.

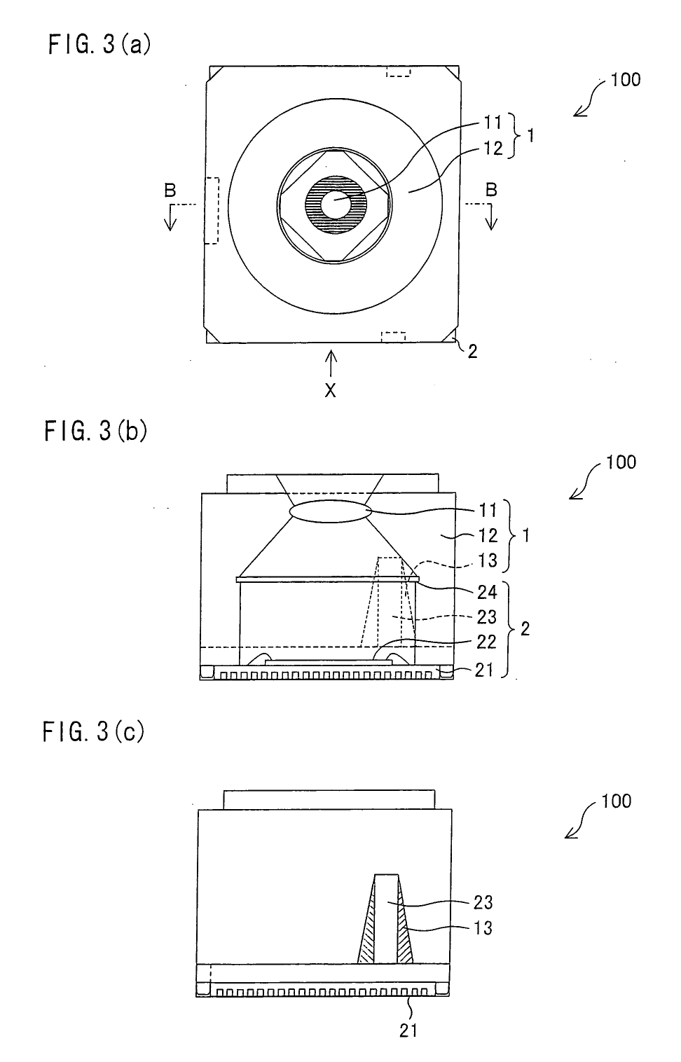

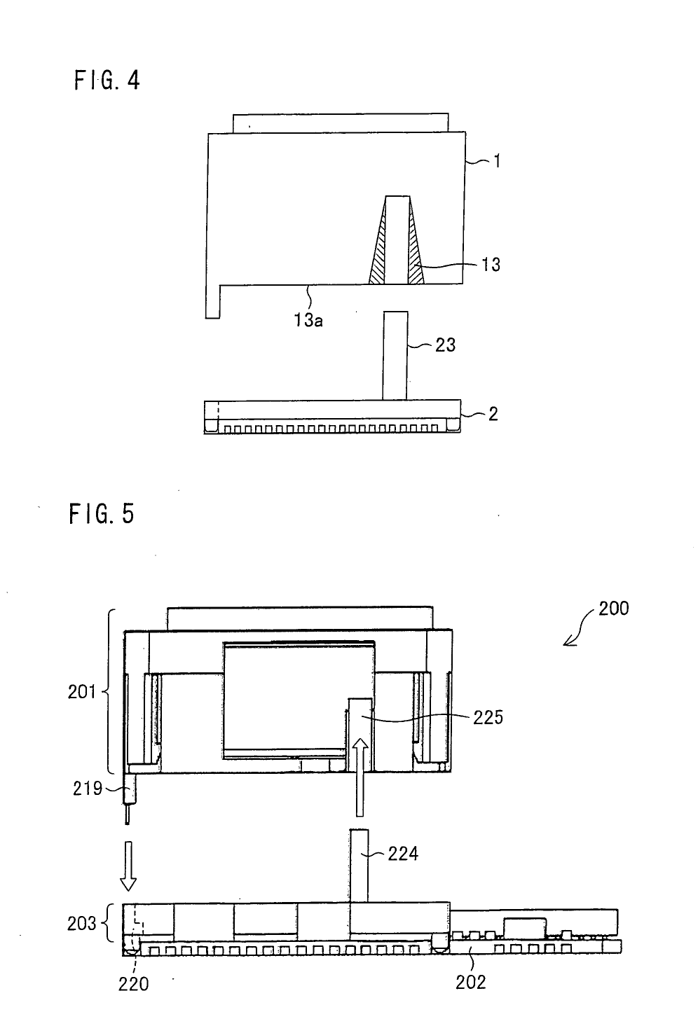

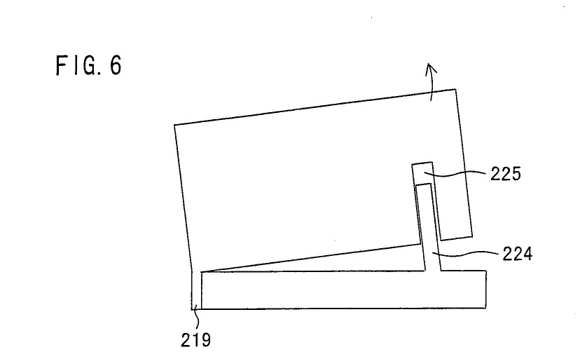

FIG. 3(a) is a plan view (top view) of a camera module 100 according to the present embodiment. FIG. 3(b) is a cross-sectional view taken along B-B line of the camera module 100 shown in FIG. 3(a). FIG. 3(c) is a side view of the camera module 100 viewed in the X direction. FIG. 4 is an exploded view of the camera module 100.

As shown in FIG. 3(a), the camera module 100 is manufactured by combining a lens unit (an optical unit) 1 with an imaging unit 2. The camera module 100 is arranged such that the lens unit 1 is mounted on the imaging unit 2. In an explanation below, the side where the lens unit 1 is located is put as the upper side and the side where the imaging unit is located is put as the lower side, for the sake of easy explanation.

The lens unit 1 is an imaging optical system (optical structure) forming a camera subject image. In other words, the lens unit 1 is an optical path defining device for leading external light to a light-receiving surface (imaging plane) of the imaging unit 2.

As shown in FIG. 3(a), the lens unit 1 includes a lens 11 and a lens holder 12 holding (supporting) the lens 11 inside thereof. The lens 11 is arranged above a center of the lens holder 12. Further as described later, the lens holder 12 is arranged such that the lens holder 12 holds a transparent lid section 24 of the imaging unit 2.

Further, as shown in FIG. 3(b), a cutout part 13 into which a projection 23 is to be inserted is formed in the lens holder 12. Details of the cutout part 13 and the projection 23 are described later.

The imaging unit 2 is an imaging section which converts into an electronic signal the camera subject image formed by the lens unit 1. In other words, the imaging unit 2 is a sensor device which photoelectrically converts incident light coming from the lens unit 1.

As shown in FIG. 3(b), the imaging unit 2 includes a wiring board 21, a solid-state imaging element 22, the projection 23 and the transparent lid section 24. The imaging unit 2 includes a DSP (not shown) (digital signal processor (not shown)) on the wiring board 21. The imaging unit 2 is arranged such that the solid-state imaging element 22 is on the DSP which is on the wiring board 21.

The wiring board 21 has a patterned wiring (not shown). Examples of the wiring board 21 encompass a print board, a ceramic board and the like.

The solid-state imaging element 22 converts into an electronic signal the camera subject image formed in the lens unit 1. In other words, it is a sensor device which photoelectrically converts the incident light coming from the lens unit 1. For example, the solid-state imaging element 22 may be a CCD or a CMOS sensor IC. A light-receiving surface where a plurality of pixels are arranged in a matrix state is formed on a surface (upper surface) of the solid-state imaging element 22. This light-receiving surface is an area (light transmitting area) which allows light entering from the lens unit 1 to pass therethrough. The light-receiving surface can be called a pixel area in other words. The imaging surface of the imaging unit 2 is this light-receiving surface (pixel area).

The solid-state imaging element 22 converts into an electronic signal the camera subject image formed on this light-receiving surface (pixel area), and outputs the electronic signal as an analogue image signal. Specifically, the photoelectric conversion is performed on this light-receiving surface. Operations of the solid-state imaging element 22 is controlled in the DPS. The image signal generated in the solid-state imaging element 22 is processed in the DSP.

By inserting the projection 23 into the cutout part 13 of the lens unit 1 as shown in FIG. 4, the lens unit 1 and the imaging unit 2 are engaged with each other detachably. The projection 23 is explained later.

The transparent lid section 24 is made of a transparent material such as glass, resin or the like. The transparent lid section 24 is supported by the lens holder 12 so that the light-receiving surface of the solid-state imaging element 22 is covered with the transparent lid section 24. Further, the transparent lid section 24 is arranged so that a sealed off space (a gap, empty space) is formed between the transparent lid section 24 and the solid-state imaging element 22. By forming such a sealed off space, the invasion of moisture into the light-receiving surface, the invasion and the adhesion of dust to the light-receiving surface can be prevented. This makes it possible to prevent defects from appearing in the light-receiving surface.

An infrared ray blocking film may be provided on the surface of the transparent lid section 24 (which surface is opposite to the lens 11). In this case, the transparent lid section 24 has a function to block infrared rays.

The DSP is a semiconductor chip for controlling the operations of the solid-state image sensor 22, and processing the signal outputted from the solid-sate imaging element 22. Note that the wiring board 21 includes a CPU performing various kind of arithmetic operations according to a program, a ROM containing the program, and electronic parts such as a RAM for storing the data and the like under processing. And the whole camera module 100 is controlled by these electronic parts.

In the imaging operation of the camera module 100 configured as above, the external light is led to the light-receiving surface (imaging plane) by the lens unit 1, and the camera subject image is formed on the light-receiving surface. The camera subject image is converted into the electronic signal by the imaging unit 2. Various kind of processing (image processing and the like) is performed to the electronic signal.

The most unique point of the camera module 100 lies in that the lens unit 1 and the image unit 2 are engaged with each other and the engagement can be released easily. FIG. 2(a) is a cross-sectional view of the camera module 100. And FIG. 2(b) is a top perspective view of the camera module 100 shown in FIG. 2(a).

As shown in FIG. 2(a) and FIG. 2(b), the camera module 100 includes the projection 23 on the imaging unit 2. The projection 23 is protruded (extended) toward the lens unit 1. Further, the camera module 100 includes a cutout part 13 on the lens unit 1. The cutout part 13 corresponds to the projection 23. The cutout part 13 is a ditch formed on the lens unit 1. The projection 23 is inserted into the cutout part 13 in the camera module 100, whereby the lens unit 1 and the imaging unit 2 are engaged (fixed) with each other detachably. Furthermore, because the cutout part 13 and the projection 23 constitute one pair, the lens unit 1 is arranged in an appropriate position in the imaging unit 2.

As above, in the camera module 100, the projection 23 and the cutout part 13 are not only engaging sections which engage the lens unit 1 with the imaging unit 2 but also alignment sections of each unit. In the camera module 100, no adhesive is used in fixing the lens unit 1 with the imaging unit 2.

In the case where the slant line sections of the cutout part 13 are not removed and the cutout part 13 fits with the projection 23 as shown in FIG. 2(a), when detaching the lens unit 1 from the imaging unit 2, a movement of the projection 23 is restricted by the cutout part 13 until the projection 23 comes out of the cutout part 13 completely. Consequently, a large amount of load is applied on the projection 23 continuously, and the projection 23 breaks.

As shown in FIG. 2(a), the camera module 100 according to the present embodiment is configured such that the cutout part 13 has a cross-sectional shape that is in parallel with an opening surface 13a and becomes smaller inwardly of the lens unit 1. Specifically, the cutout part 13 becomes thinner gradually from the opening surface 13a to a depth direction of the cutout part 13. That is to say, a side surface of the cutout part 13 is removed thereby to be tapered. The cutout part 13 inclines so that it becomes narrower inwardly of the lens unit 1. Specifically, in the cutout part 13, an opening (opening surface 13a) into which the projection 23 is to be inserted is wider than the projection 23. The cutout part 13 becomes narrower gradually. In the camera module 100 according to the present embodiment, as shown in FIG. 2(a), the cutout part 13 has a cross-sectional shape vertical to the opening 13a is trapezoidal. In other words, the cutout part 13 is a conic trapezoid.

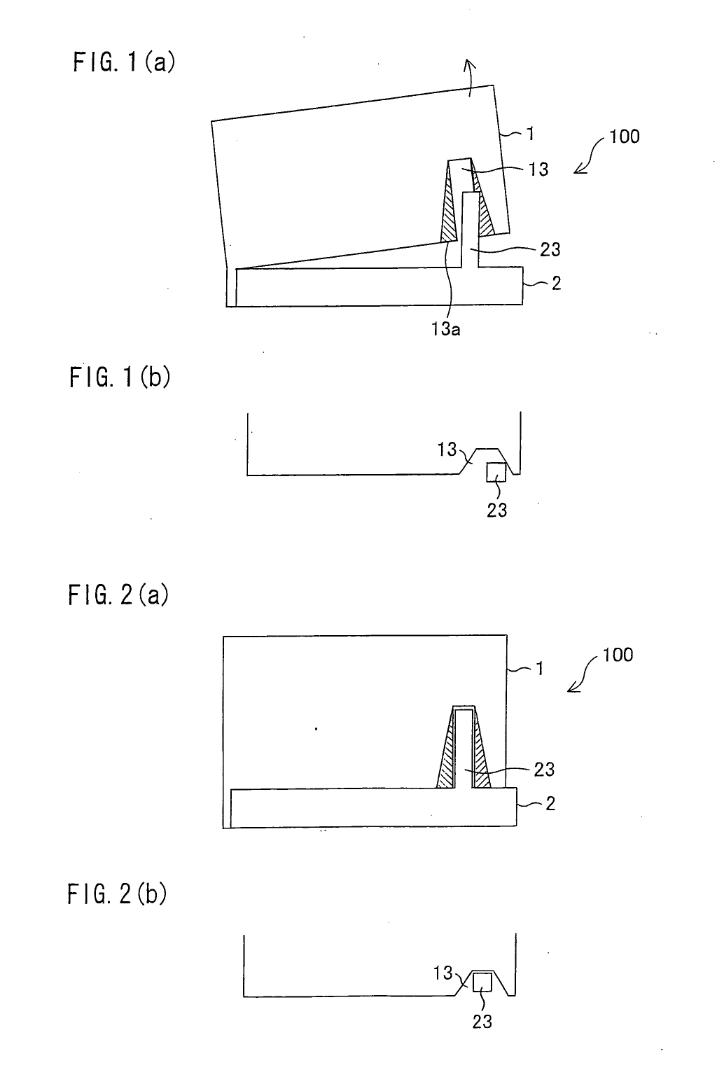

The following explains a relation between the cutout part 13 and the projection 23 when detaching the lens unit 1 from the imaging unit 2. FIG. 1(a) is a cross-sectional view showing the camera module 100 while detaching the lens unit 1 from the imaging unit 2. FIG. 1(b) is a top perspective view of the camera module shown in FIG. 1(a).

As shown in FIG. 2(a) and FIG. 2(b), in the case where the lens unit 1 and the imaging unit 2 are engaged with each other, the projection 23 is situated in an end section of the cutout part 13. Because an end surface of the cutout part 13 (bottom surface of the cutout part 13) has the same shape as an end surface of the projection 23, each unit is engaged with each other. In this state of engagement, a movement of the projection 23 is restricted so that the projection 23 doesn't move from the cutout part 13.

As mentioned above, in the present embodiment, the cutout part 13 has a cross-sectional shape that is in parallel with the opening surface 13a and that becomes smaller inwardly of the lens unit 1. Specifically, a side surface of the cutout part 13 is removed (i.e., the cutout part 13 is tapered) so that the cutout part 13 becomes thinner (narrower) inwardly of the lens unit 1. In other words, the cutout part 13 becomes wider into the direction where lens unit 1 is removed from the imaging unit 2. Thus, as shown in FIG. 1(a) and FIG. 1(b), just by moving the lens unit 1 relative to the imaging unit 2, an engagement of each unit can be easily released.

Further, as shown in FIG. 1(a), when an engagement of the lens unit 1 and the imaging unit 2 is released, the projection 23 can move inside the cutout part 13, even in the middle of detaching each unit (before the projection 23 comes out of the cutout part 13 completely). Thus, as long as the engagement of the lens unit 1 and the imaging unit 2 is released, an excessive amount of force is not applied on the projection 23 even in the middle of detaching each unit. This makes it possible to prevent breaking of the projection 23 when detaching the lens unit 1 and the imaging unit 2.

As above, if each unit can be easily detached while breaking of the projection 23 can be prevented, a detaching step can be shortened, and cost of constructing the camera module 100 can be reduced. Even if defects are found on one unit after completion of the camera module 100, it is possible to exchange only the unit with defects. The unit with defects can be reused after being repaired. Therefore it is easy to detach and exchange (repair) each unit in the case where defects are found in the test after manufacturing the camera module 100. Further, because the detached unit has no damage and can be repaired, an efficiency of reusing units increases.

Further, in the camera module 100 of the present embodiment, as shown in FIG. 1(a), a side wall of the lens unit 1 fits with a side wall of the imaging unit 2. Thus, when the lens unit 1 is rotated with respect to the imaging unit 2, it is easy to detach each unit. However this applies a large amount of load on the projection 23 and thereby breaks the projection 23 easily. The same is true for the case of rotating the lens unit 1. Thus, it is preferable that the cutout part 13 be shaped such that an engagement of the lens unit 1 and the image unit 2 by the cutout part 13 and the projection 23 is released in accordance with the rotation of the lens unit 1. With this arrangement, a large amount of load is not applied to the projection 23 and the engagement of each unit can be released when detaching each unit. Therefore, each unit can be easily detached while more effectively breaking of the projection 23 can be prevented. As above, it is especially preferable that cross-sectional views of the cutout part 13 be conic trapezoids in order to release the engagement of each unit easily.

The camera module 100 according to the present invention includes one pair of the cutout part 13 and the projection 23. However, the camera module 100 may include more than one pair of the cutout part 13 and the projection 23. In this case, it is preferable that both pairing types of the pairs of the projections 23 and the cutout parts 13 are provided on the lens unit 1 and the imaging unit 2 respectively. Specifically, for example, a projection of a certain pair (referred to as 23A for the sake of easy explanation) and a cutout part of the other pair (referred to as 13A for the sake of easy explanation) are provided on the lens unit 1. A cutout part (referred to as 13B for the sake of easy explanation) corresponding to the projection 23A of the certain pair and a projection (referred to as 23B for the sake of easy explanation) corresponding to the cutout part 13A of the other pair are provided on the imaging unit 2. Thus, in one part, the lens unit 1 and the imaging unit 2 are engaged by the projection 23A of the lens unit 1 and the cutout part 13A of the imaging unit 2. In the other part, the engagement is performed by the cutout part 13B of the lens unit 1 and the projection 23B of the imaging unit 2. Specifically, forms of the engagement between each unit are different. Therefore, each unit can be engaged surely and solidly. The lens unit 1 can be surely arranged in an appropriate position on the imaging unit 2.

As explained above, a camera module according to the present invention includes a cutout part (i) which has a cross-sectional shape that is in parallel with an opening thereof and that becomes smaller inwardly of the unit in which the cutout part is provided, and (ii) by which an optical unit and an imaging unit are engaged with each other by inserting a projection into the cutout part. Thus, when detaching each unit, breaking of the projection can be prevented and each unit can be easily detached.

In the camera module according to the present invention, it is preferable that when rotating the optical unit endways or sideways relatively to the imaging unit, the engagement of the optical unit and the imaging unit be released in accordance with the rotation.

The optical unit and imaging unit can be easily detached from each other by rotating the optical unit endways or sideways relatively to the imaging unit. In this case, however, because a large amount of load is applied to a projection, the projection especially can be easily broken.

According to the above arrangement, a cutout part is formed so that the engagement of the projection and the cutout part can be released in accordance with the rotation of the optical unit. Thus, a large amount of load will not be applied to the projection when detaching the units from each other. Therefore, the disengagement of the unit can be performed easily while more effectively preventing the breaking of the projection.

In order to release the engagement of each unit easily as above, it is preferable that the cutout part have a cross-sectional shape vertical to the opening is trapezoidal. With this arrangement, the disengagement of the unit can be performed easily while effectively preventing the breaking of the projection. Further, the cutout part can be easily formed on the units.

In the camera module according to the present invention, it is preferable that the pairs of the projections and the cutout parts be plural; and both pairing types of the pairs of the projection and the cutout part be provided on the optical unit and the imaging unit respectively.

According to the above arrangement, a projection of a certain pair and a cutout part of the other pair are provided on one unit, and a cutout part corresponding to the projection of the certain unit and a projection corresponding to the cutout part of the other pair are provided on the other unit. Thus, in one part, each unit is engaged by the projection of the optical unit and the cutout part of the imaging unit, and in the other part each unit is engaged by the cutout part of the optical unit and the projection of the imaging unit. Specifically, forms of the engagement between each unit are different. Therefore, each unit can be engaged surely and solidly. Further, the optical unit can be arranged surely in an appropriate position on the imaging unit.

An electronic device according to the present invention includes any one of the above camera modules. This makes it possible to provide an electronic device in which the breaking of the projection can be prevented and each unit can be easily detached from each other.

The present invention can be applied to camera modules (solid-state imaging devices) used for imaging in various kinds of imaging devices (electronic devices) such as camera-equipped mobile phones, digital still cameras, security cameras, cameras for mobile phones, cameras equipped on vehicle, and cameras for intercoms.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A camera module including an optical unit including a lens for leading external light to a solid-state imaging element; and an imaging unit where the solid-state imaging element is mounted on a substrate, the camera module comprising:
at least one pair of a projection and a cutout part corresponding to the projection, the projection being provided on at least one of the optical unit and the imaging unit, and the cutout part being provided on that one of the optical unit and the imaging unit on which the projection to which the cutout part corresponds is not provided,
the optical unit and the imaging unit being engaged with each other by inserting the projection into the cutout part, and
the cutout part being having a cross-sectional shape that is in parallel with an opening thereof and that becomes smaller inwardly of that one of the optical unit and the imaging unit in which the cutout part is provided.

2. The camera module according to claim 1 wherein:
the cutout part is shaped such that when rotating the optical unit endways or sideways relatively to the imaging unit, the engagement of the optical unit and the imaging unit is released in accordance with the rotation.

3. The camera module according to claim 1 wherein:
the cutout part has a cross-sectional shape vertical to the opening is trapezoidal.

4. The camera module according to claim 1, wherein:
the pairs of the projections and the cutout parts are plural; and
both pairing types of the pairs of the projection and the cutout part are provided on the optical unit and the imaging unit respectively.

5. An electronic device including a camera module, the camera module comprising:
an optical unit including a lens for leading external light to a solid-state imaging element;
an imaging unit where the solid-state imaging element is mounted on a substrate; and
at least one pair of a projection and a cutout part corresponding to the projection, the projection being provided on at least one of the optical unit and the imaging unit, and the cutout part being provided on that one of the optical unit and the imaging unit on which the projection to which the cutout part corresponds is not provided,
the optical unit and the imaging unit being engaged with each other by inserting the projection into the cutout part, and
the cutout part being having a cross-sectional shape that is in parallel with an opening thereof and that becomes smaller inwardly of that one of the optical unit and the imaging unit in which the cutout part is provided.
